(19) United States
(12) Patent Application Publication
(10) Pub. No.: US 2018/0268490 A1
(43) Pub. Date: Sep. 20, 2018

(54) IDENTIFYING USER EXPLOITATION OF ONE OR MORE CONTENT SELECTION PROCESSES USED BY AN ONLINE SYSTEM

(71) Applicant: Facebook, Inc., Menlo Park, CA (US)

(72) Inventors: Eric Michael Sodomka, Menlo Park, CA (US); Anand Sumatilal Bhalgat, Mountain View, CA (US); Chandrashekhar Nagarajan, Cupertino, CA (US); Dominic Coey, Palo Alto, CA (US); Nicolas Emilio Stier Moses, Palo Alto, CA (US); Brent Christian Dorman, Seattle, WA (US); Molly Katherine Duffy, San Francisco, CA (US)

(21) Appl. No.: 15/462,317

(22) Filed: Mar. 17, 2017

(51) Int. Cl. G06Q 40/00; H04L 29/08

(52) U.S. Cl. CPC G06Q 40/12; G06Q 50/01; H04L 67/20; H04L 67/306

(57) ABSTRACT

An online system receives content items from publishing users for presentation to other users. When selecting content for presentation to users, the online system accounts for amounts of compensation from publishing users when presenting content items. To prevent publishing users from exploiting content selection by the online system to obtain disproportionate presentation of their content items relative to other publishing users, the online system generates an estimated amount of revenue from various publishing users from presenting their content items. The online system compares an amount of compensation received from a publishing user to the estimated amount of revenue from the publishing user, and generates clusters of content items from the publishing user for review if the amount of compensation is at least a threshold amount less than the estimated amount of revenue.

### BACKGROUND

This disclosure relates generally to recommending content to online system users, and more specifically to selection of content items for users by an online system.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

When an online system identifies an opportunity to present content to a user, the online system may account for amount of compensations to be received from various publishing users in exchange for presenting content items received form the publishing users. For example, the online system ranks content items from various publishing users based on amounts of compensation to be provided by the publishing users in exchange for presenting various content items and selects content for the user based on the ranking. While publishing users generally include bid amounts in content items that represent values to the publishing users for presentation of the content items, publishing users may attempt to exploit errors or inaccuracies in selection processes used by the online system that may allow a publishing user to obtain disproportionate presentation of its content items by the online system relative to compensation provided to the online system for presentation. For example, an inaccuracy in a selection process used by the online system allows a publishing user to provide lower bid amounts in content items, while maintaining a relatively high likelihood that content items providing larger value to the publishing user, benefiting the publishing user at the expense of the online system.

### SUMMARY

An online system receives content items from various publishing users and selects content including one or more of the received content items for presentation to other users. For example, the online system identifies an opportunity to present content to a user, retrieves content items received from one or more of the publishing users, and uses one or more selection processes to select content items for presentation to the user via the identified opportunity. This allows publishing users to distribute content items via the online system, which may increase a number of users to whom content items from a publishing user are presented or may increase likelihoods of content items from the publishing user being presented to users who are likely to be interested in the content items or to interact with the content items.

Many publishing users provide compensation to the online system in exchange for presenting content items received from the publishing user. Content items received from a publishing user include a bid amount in various embodiments. The bid amount included in a content item specifies an amount of compensation a publishing user from whom the online system received the content item provides the online system in exchange for presenting a content item to other users or in exchange for other users performing an action after being presented with the content item. Different content items may include different types of bid amounts, where a type of bid amount includes criteria that, when satisfied, cause a publishing user to provide compensation to the online system. For example, a type of bid amount causes the publishing user to provide compensation to the online system in response to the online system presenting the content item, while another type of bid amount causes the publishing user to provide the online system with compensation in response to a user performing a particular action after being presented with the content item.

When selecting content for presentation to users via identified opportunities, the online system accounts for bid amounts included in content items received from various publishing users. For example, a selection process used by the online system to select content for presentation to a user identifies content items received from one or more publishing users, determines expected values for each of the identified content items based on bid amounts included in each content item and likelihoods of the user performing one or more interactions with each of the identified content item, and selects one or more of the identified content items based on the determined expected values. In various embodiments, the online system determines an expected value for a content item as a product of a bid amount included in the content item and a likelihood of the user performing one or more interactions with the content item.

Publishing users generally include bid amounts in content items that represent values to the publishing users for presentation of the content items. For example, a publishing user generally includes a higher bid amount in a content item that includes content identifying a product or service valuable to the publishing user than bid amounts included in content items identifying less valuable product or services. As another example, a publishing user includes a higher bid amount in a content item having an objective specifying a desired action providing the publishing user with a greater benefit than bid amounts included in other content items having objectives specifying desired actions providing the publishing user with relatively smaller benefits. However, publishing users may attempt to exploit errors or inaccuracies in one or more of the selection processes used by the online system that may allow a publishing user to provide lower bid amounts in content items that reduce the compensation provided to the online system by the publishing users, while maintaining a relatively high likelihood that content items providing relatively high values to the publishing user are presented by the online system. This may allow a publishing user to disseminate content to users via the online system while reducing compensation received by the online system for disseminating the publishing user's content.

To reduce exploitation of one or more selection processes used by the online system by publishing users, the online system generates an estimated amount revenue to the online system for presenting one or more content items received from each publishing user. In various embodiments, the online system generates an estimated amount of revenue for presenting content items received from a publishing user based on characteristics of the publishing user and characteristics of content items received from the publishing user. For example, the online system trains one or more machine learned models based on prior presentation of content items received from publishing users to other online system users. The online system applies the one or more machine learned models to content items received from a publishing user and to characteristics of the publishing user to generate the estimated amount revenue for presentation of content items received from the publishing user. In some embodiments, the estimated revenue specifies an amount of compensation the online system receives during a specific time interval for presenting content items received from the publishing user. The online system stores the estimated amount of revenue generated for a publishing user in association with information identifying the publishing user.

As the online system presents content items from various publishing users to users of the online system, the online system obtains compensation from the publishing users in response to presenting content items from the publishing users or in response to receiving actions by users after being presented with content items from the publishing users. For example, the online system obtains compensation from a publishing user in response to the online system presenting a content item from the publishing user to another user. As another example, the online system obtains compensation from a publishing user in response to the online system receiving a description of an action by another user presented with a content item from the publishing user including an objective specifying the action.

Based on the amounts of compensation obtained from publishing users for presentation of content items from the publishing users, the online system determines an amount of revenue received from each of at least a set of the publishing users for presenting one or more content items from publishing users of the set. For example, the online system totals compensation obtained from a publishing user during a particular time interval to determine the amount of revenue received from the publishing user. In some embodiments, the online system determines an amount of revenue received from each publishing user from whom the online system received content items.

The online system identifies one or more particular publishing users by comparing the determined amount of revenue for various publishing users to the estimated revenue generated for corresponding publishing users. A particular publishing user is identified as a publishing user from whom the determined amount of revenue is at least a threshold amount less than the estimated amount of revenue generated for the publishing user. In various embodiments, the threshold amount is a multiple of the estimated amount of revenue in various embodiments, and the online system may determine the multiple based on amounts of revenue previously received from publishing users or based on any other suitable criteria. Additionally, the online system may modify the multiple used to determine the threshold amount over time, as content items are presented to online system users, in various embodiments.

For each of the particular publishing users, the online system generates clusters of content items received from the particular publishing users. The clusters are generated based on characteristics of content items received from a particular publishing user so content items in different clusters have different common or similar characteristics. In one embodiment, the online system generates vectors representing each content item received from a particular publishing user based on characteristics of the content items. In one embodiment, a vector generated for a content item has a number of dimensions equaling a number of characteristics of the content item. The online system may maintain a set of characteristics used to generate the vectors, so a vector has a number of dimensions equaling a number of characteristics in the set. Each dimension of a vector is assigned a value by the online system based on a characteristic of a content item corresponding to a dimension of the vector. Based on the vectors representing various content items, for each particular publishing user, the online system 140 generates clusters of content items received from a particular publishing user, so different clusters include content items received from a particular publishing user that have different combinations of characteristics. In one embodiment, the online system 140 uses K-means clustering to generate the clusters based on the vectors representing various content items received from a particular publishing user.

The online system subsequently reviews the generated clusters of content items to identify a characteristic, or a characteristic, of content items enabling disproportionate presentation of certain content items from particular publishing users relative to compensation provided to the online system by the particular publishing users. Clustering the content items from a particular user allows the online system to more efficiently review various content items by allowing different content items having common or similar characteristics to be reviewed together. In various embodiments, the online system provides the generated clusters to human reviewers who evaluate characteristics of the content items included in various clusters. In various embodiments, human reviewers determine a rate at which content items having at least a threshold amount of characteristics matching characteristics of content items included in a generated cluster including content items received from a particular publishing user have been received from different publishing users or determine a number of publishing users from whom content items having at least a threshold amount of characteristics matching characteristics of content items included in the cluster have been received. If content items having at least the threshold amount of characteristics matching characteristics of content items in a cluster have been received from less than a threshold amount of users or have been received at less than a threshold rate, the online system determines the particular publishing user from whom the content items in the cluster were received is attempting to exploit the online system and performs one or more remedial actions affecting presentation of content items received from the particular publishing user. For example, the online system withholds content items received from the particular publishing user from inclusion in subsequent selection processes. As another example, the online system requests additional compensation form the particular publishing user as a remedial action. When determining a remedial action against the particular publishing user, the online system may account for an amount of compensation received from the particular publishing user over a time interval, as well as a length of time the particular publishing user has provided content items to the online system for presentation.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flowchart of a method to identify exploitation of selection processes used by the online system to select content items for presentation to users, in accordance with an embodiment.

FIG. 4 is a conceptual diagram showing review of review of content items received by an online system from a particular publishing user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

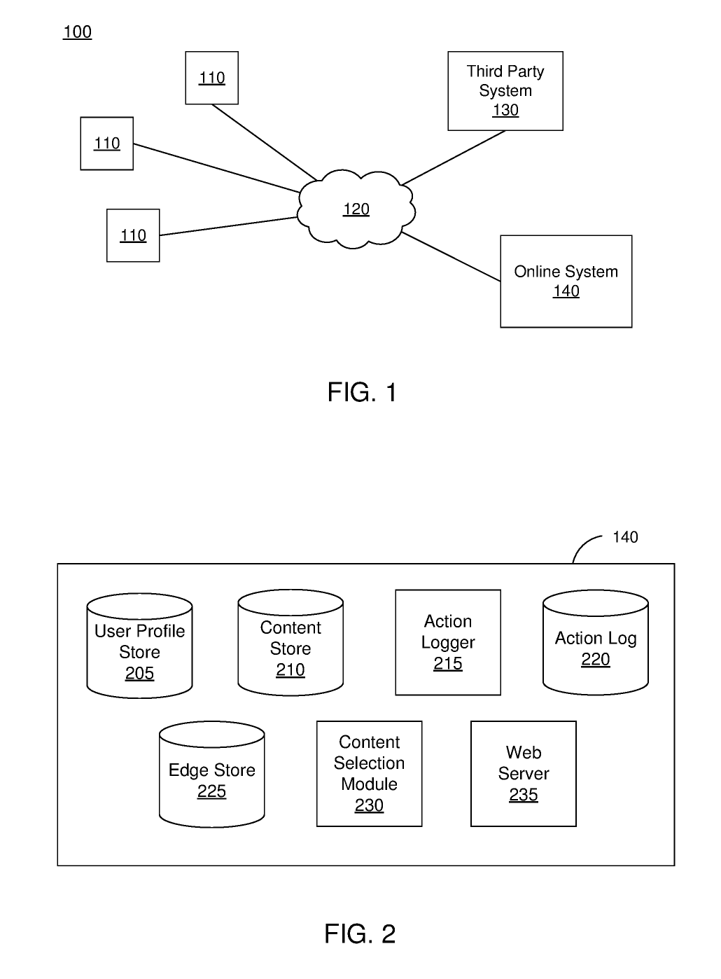

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store 210 for subsequent retrieval by the content selection module 230, which is further described below.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

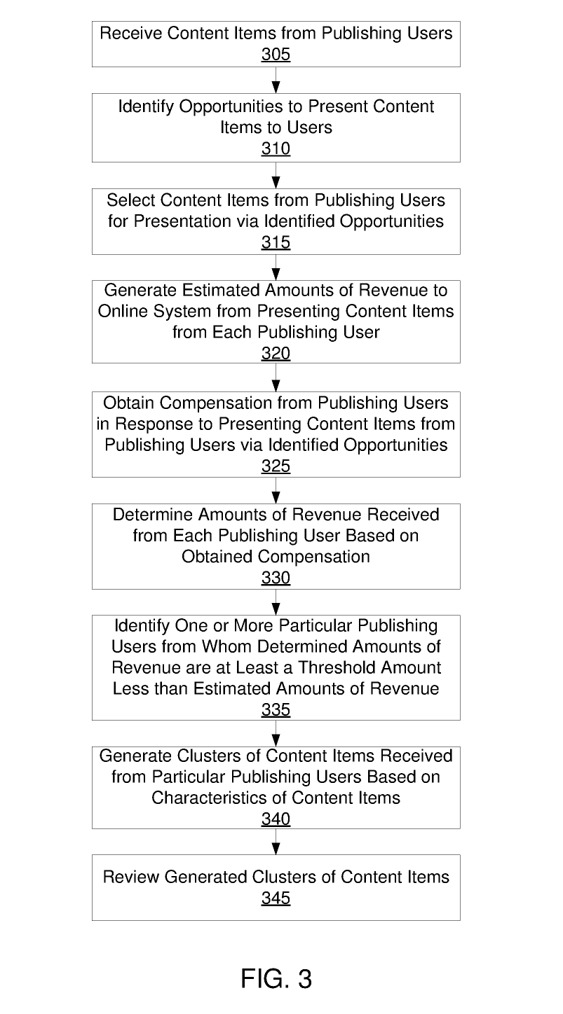

In various embodiments, the content selection module 230 also identifies publishing users providing content items to the online system 140 for presentation to other users who attempt to exploit the one or more selection processes used by the content selection module 230. For example a publishing user attempts to exploit a selection process implemented by the content selection module 230 that allows the publishing user to provide lower bid amounts in content items that reduce the compensation provided to the online system 140, while maintaining a relatively high likelihood that the content selection module 230 selects content items from the publishing user for presentation. To prevent publishing users from exploiting one or more selection processes, the content selection module 230 determines estimated amounts of revenue to be received from various publishing users and compares compensation received from publishing users to estimated amounts of revenue from corresponding publishing users, as further described below in conjunction with FIG. 3. If the content selection module 230 determines compensation received from a publishing user is at least a threshold amount less than the estimated amount of revenue from the publishing user, the content selection module 230 retrieves content items from the content store 210 associated with the publishing user. The content selection module 230 generates clusters of the retrieved content items based on characteristics of the retrieved content items and reviews content items in the various clusters to determine whether the publishing user is exploiting one or more selection processes, as further described below in conjunction with FIG. 3.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

### Determining Exploitation of Content Selection by an Online System

FIG. 3 is a flowchart of one embodiment of a method for an online system 140 to identify exploitation of selection processes used by the online system 140 to select content items for presentation to users. In other embodiments, the steps described in conjunction with FIG. 3 may be performed in different orders. Additionally, in some embodiments, the method may include different and/or additional steps than those shown in FIG. 3.

The online system 140 receives 305 content items from publishing users for presentation to other users of the online system 140. As further described above in conjunction with FIG. 2, content items received from a publishing user include a bid amount specifying an amount of compensation the publishing user provides the online system 140 in exchange for presenting a content item to other users or in exchange for other users performing an action after being presented with the content item. A publishing user may provide the online system 140 with a campaign including multiple content items, as further described above in conjunction with FIG. 2.

As the online system 140 identifies 310 opportunities to present content to online system users, the online system 140 selects 315 content items received 305 from one or more publishing users for presentation to the users via the identified opportunities. For example, a client device 110 associated with a user requests content from the online system 140, so the online system 140 identifies content items from one or more publishing users and selects 315 content items for presentation via the client device 110 by including the identified content items in one or more selection processes. As described above in conjunction with FIG. 2, a selection process uses bid amounts included in various identified content items to select 315 content items for presentation via an opportunity. For example, the selection process determines expected values for various content items based on a probability of a user for whom an opportunity was identified 310 performing one or more interactions when presented with the content items and bid amounts included in the content items. The selection process ranks content items based on their expected values and selects 315 content items having at least a threshold position in the ranking for presentation. Content items selected 315 for a user are communicated from the online system 140 to a client device 110 associated with the user for presentation.

Publishing users generally include bid amounts in content items that represent values to the publishing users for presentation of the content items. For example, a publishing user generally includes a higher bid amount in a content item that includes content identifying a product or service valuable to the publishing user than bid amounts included in content items identifying less valuable product or services. As another example, a publishing user includes a higher bid amount in a content item having an objective specifying a desired action providing the publishing user with a greater benefit than bid amounts included in other content items having objectives specifying desired actions providing the publishing user with relatively smaller benefits. However, publishing users may attempt to exploit errors or inaccuracies in one or more of the selection processes used by the online system 140 that may allow a publishing user to provide lower bid amounts in content items that reduce the compensation provided to the online system 140 by the publishing users, while maintaining a relatively high likelihood that content items providing relatively high values to the publishing user are presented by the online system 140. This may allow a publishing user to disseminate content to users via the online system 140 while reducing compensation received by the online system 140 for disseminating the publishing user's content.

To prevent publishing users from exploiting one or more selection processes used by the online system 140 that may allow publishing users to distribute content via the online system 140 disproportionate to the amount of compensation the publishing users provide the online system 140, the online system 140 generates 320 an estimated amount revenue to the online system 140 for presenting one or more content items received from each publishing user. In various embodiments, the online system 140 generates 320 an estimated amount of revenue for presenting content items received from a publishing user based on characteristics of the publishing user and characteristics of content items received 305 from the publishing user. For example, the online system 140 trains one or more machine learned models based on prior presentation of content items received 305 from publishing users to other online system users. The online system 140 applies the one or more machine learned models to content items received 305 from a publishing user and to characteristics of the publishing user to generate 320 the estimated amount revenue for presentation of content items received 305 from the publishing user. In some embodiments, the estimated revenue specifies an amount of compensation the online system 140 receives during a specific time interval for presenting content items received 305 from the publishing user. The online system 140 stores the estimated amount of revenue generated 320 for a publishing user in association with information identifying the publishing user.

In some embodiments, the online system 140 generates 320 the estimated amount of revenue for publishing users as a probability distribution of amounts of revenue from publishing users in response to presenting content items received 305 from publishing users via different numbers of identified opportunities. The online system 140 determines a probability distribution for each publishing user and stores a probability distribution in association with a corresponding publishing user. A probability distribution associated with a publishing user indicates probabilities of the online system 140 receiving different amounts of revenue from the publishing user for presenting content items received 305 from the publishing users via different numbers (or amounts) of identified opportunities. The online system 140 may maintain one or more machine learning models that generate a probability distribution for a publishing user based on characteristics of the publishing user and characteristics of content items received from the publishing user. One or more of the machine learned models may be trained based on previously presented content items received from publishing users, characteristics of publishing users from whom the previously presented content items were received 305, and amounts of compensation received by the online system 140 from publishing users from whom the previously presented content items were received 305.

As the online system 140 presents content items from various publishing users to users of the online system 140, the online system 140 obtains 325 compensation from the publishing users in response to presenting content items from the publishing users or in response to receiving actions by users after being presented with content items from the publishing users. For example, the online system 140 obtains 325 compensation from a publishing user in response to the online system 140 presenting a content item from the publishing user to another user. As another example, the online system 140 obtains 325 compensation from a publishing user in response to the online system 140 receiving a description of an action by another user presented with a content item from the publishing user including an objective specifying the action. Based on the amounts of compensation obtained 325 from publishing users for presentation of content items from the publishing users, the online system 140 determines 330 an amount of revenue received from each of at least a set of the publishing users for presenting one or more content items from publishing users of the set. For example, the online system 140 totals compensation obtained 325 from a publishing user during a specific time interval to determine 330 the amount of revenue received from the publishing user. In some embodiments, the online system 140 determines 330 an amount of revenue received from each publishing user from whom the online system 140 received 305 content items.

By comparing the determined amount of revenue for various publishing users to the estimated revenue generated 320 for the publishing users, the online system 140 identifies 335 one or more particular publishing users from whom the determined amount of revenue is at least a threshold amount less than the estimated amount of revenue generated 320 for a corresponding particular publishing user. In various embodiments, the online system 140 compares a determined amount of revenue from a publishing user to an estimated amount of revenue generated 320 for the publishing user and identifies 335 the publishing user as a particular publishing user if the determined amount of revenue is at least the threshold amount less than the estimated amount of revenue. The threshold amount is a multiple of the estimated amount of revenue in various embodiments, and the online system 140 may determine the multiple based on amounts of revenue previously received from publishing users or based on any other suitable criteria. Additionally, the online system 140 may modify the multiple used to determine the threshold amount over time, as content items are presented to online system users, in various embodiments.

Alternatively, the online system 140 identifies 335 the one or more particular publishing users based on probability distributions of amounts of revenue from publishing users in response to presenting content items received 305 from publishing users for various identified opportunities to present content to online system users and amounts of compensation obtained 325 from publishing users who provided the online system 140 with content items that were presented by the identified opportunities. When the online system 140 presents a content item received 305 from a publishing user via an identified opportunity and obtains 325 compensation from the publishing user for presentation of the content item via the identified opportunity, the online system 140 determines a position of the obtained compensation in the probability distribution associated with the publishing user. The online system 140 determines a number of identified opportunities where a content item received 305 from the publishing user was received having different positions in the probability distribution associated with the publishing user. If the online system 140 determines at least a threshold number of identified opportunities where a content item received 305 from the publishing user was presented have less than a threshold position in the probability distribution associated with the publishing user, the online system 140 identifies 335 the publishing user as a particular publishing user.

For each of the particular publishing users, the online system 140 generates 340 clusters of content items received from the particular publishing users. The clusters are generated 340 based on characteristics of content items received from a particular publishing user so content items in different clusters have different common or similar characteristics. The online system 140 may generate a vector for each content item received from the particular publishing user, with the vector generated for a content item based on characteristics of the content item. For example, the online system 140 generates vectors representing each content item received 305 from a particular publishing user based on characteristics of the content items. In one embodiment, a vector generated for a content item has a number of dimensions equaling a number of characteristics of the content item. The online system 140 may maintain a set of characteristics used to generate the vectors, so a vector has a number of dimensions equaling a number of characteristics in the set. Each dimension of a vector for a content item is assigned a value by the online system based on a characteristic of a content item corresponding to a dimension of the vector. Various methods may be used by the online system to determine the value assigned to each dimension of a vector generated for a content item. Based on the vectors representing various content items, for each particular publishing user, the online system 140 generates 340 clusters of content items received 305 from a particular publishing user, so different clusters include content items received 305 from a particular publishing user that have different combinations of characteristics. In one embodiment, the online system 140 uses K-means clustering to generate 340 the clusters based on the vectors representing various content items received 305 from a particular publishing user. Using K-means clustering causes a content item to be clustered based on the distance of each dimension of a vector representing the content item to a mean value associated with a dimension across all vectors of content items, such as all vectors of content items received 305 from the particular publishing user. For example, content items having a value associated with a dimension that is within a specified distance to a mean value associated with the dimension are included in a cluster.

The online system 140 subsequently reviews 345 the generated clusters of content items to identify a characteristic, or a characteristic, of content items enabling disproportionate presentation of certain content items from particular publishing users relative to compensation provided to the online system 140 by the particular publishing users. Clustering the content items from a particular user allows the online system 140 to more efficiently review 345 various content items by allowing different content items having common or similar characteristics to be reviewed 345 together. In various embodiments, the online system 140 provides the generated clusters to human reviewers who evaluate characteristics of the content items included in various clusters. For example, the online system 140 provides different clusters to different human reviewers, allowing different human reviewers to review content items having different common, or similar, characteristics. In various embodiments, human reviewers determine a rate at which content items having at least a threshold amount of characteristics matching characteristics of content items included in a generated cluster including content items received 305 from a particular publishing user have been received 305 from different publishing users. If content items having at least the threshold amount of characteristics matching characteristics of content items in the cluster have been received 305 from less than a threshold amount of publishing users or have been received at less than a threshold rate, the online system 140 determines the particular publishing user from whom the content items in the cluster were received 305 is attempting to exploit the online system 140 and performs one or more remedial actions affecting presentation of content items received 305 from the particular publishing user. For example, the online system 140 withholds content items received from the particular publishing user from inclusion in subsequent selection processes. As another example, the online system 140 requests additional compensation form the particular publishing user as a remedial action. When determining a remedial action against the particular publishing user, the online system 140 may account for an amount of compensation received from the particular publishing user over a time interval, as well as a length of time the particular publishing user has provided content items to the online system 140 for presentation. In some embodiments, if the particular publishing user has provided content items to the online system 140 for less than a threshold length of time, the online system 140 withholds content items from the particular publishing user for a specified time interval as a remedial action. However, if content items having characteristics of content items in a cluster have been received 305 from at least a threshold amount of users, the online system 140 may alter one or more selection processes to more accurately evaluate characteristics of content items in the cluster.

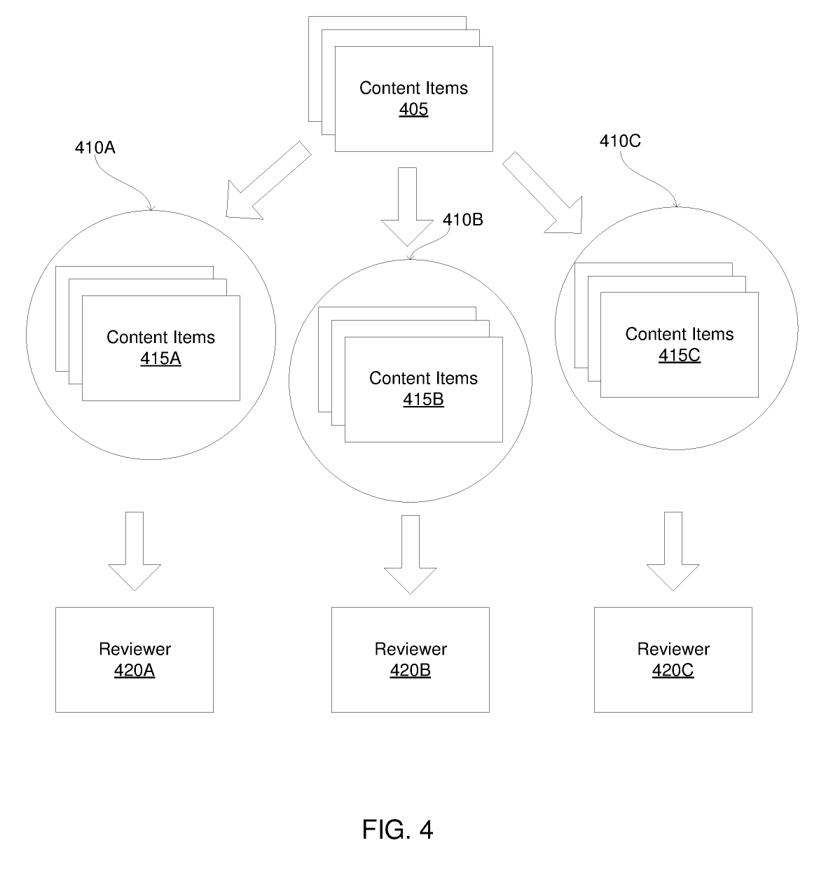

FIG. 4 is a conceptual diagram showing review of review of content items received by an online system 140 from a particular publishing user identified as providing the online system 140 with an amount of revenue at least a threshold amount less than an estimated amount of revenue determined by the online system 140. As further described above in conjunction with FIG. 3, the particular publishing user is identified because an amount of revenue received by the online system 140 from the particular publishing user for presenting content items from the particular publishing user is at least the threshold amount less than an estimated amount of revenue the online system 140 generated for presentation of content items from the particular publishing user. The online system 140 retrieves content items 405 received from the particular publishing user and generates clusters 410A, 410B, 410C based on characteristics of the retrieved content items 405. Each cluster 410A, 410B, 410C includes content items 405 having matching or similar characteristics. For example, the online system 140 generates a vector for each content item 405 based on characteristics of a content item 405 and generates the clusters 410A, 410B, 410C based on distances between vectors generated for various content items 405, as further described above in conjunction with FIG. 3. Hence, each cluster 410A, 410B, 410C includes content items 405 having one or more common characteristics. For example, cluster 410A includes content items 415A that were presented in a particular context (e.g., presented in a feed of content), cluster 410B includes content items 415B that were presented in another context (e.g., presented as content within an application), and cluster 410C includes content items 415C that were presented in an alternative context (e.g., presented in conjunction with a feed of content). However, different clusters 410A, 410B, 410C may be generated based on any characteristic, or characteristics, of the content items 405. Example characteristics of content items 405 for generating clusters 410A, 410B, 410C include: types of bid amount included in the content items 405, types of the content items 405, objectives included in the content items 405 that specify desired actions by users to whom the content items 405 were presented, contexts in which the content items 405 were presented to users, and any combination thereof.

The clusters 410A, 410B, 410C are provided human reviewers 420A, 420B, 420C who review content items 415A, 415B, 415C included in the clusters to determine characteristics of the content items 405 allowing the publishing user to cause presentation of the content items 405 by the online system 140 at a rate that is disproportionate to the amounts of compensation provided to the online system 140 by the particular publishing user. In the example shown by FIG. 4, different clusters 410A, 410B, 410C are provided to different reviewers 420A, 420B, 420C (also referred to individually and collectively using reference number 420), allowing different reviewers 420A, 420B, 420C to review content items 405 having different characteristics, while providing content items 405 having matching, or similar, characteristics to a common reviewer 420. A reviewer 420 may determine a rate at which content items received from other users have a characteristic common to content items 415 included a cluster 410 provided to the reviewer 420 are received by the online system 140 or may determine an amount of content items received from various users have the characteristic common to content items 415 included in the cluster 410 to determine whether the characteristic common to content items 415 included in the cluster 410 allows the particular publishing user to exploit one or more selection processes for presentation of content items having the characteristic common to content items included in the cluster 410 disproportionate to an amount of compensation provided to the online system 140. For example, if the reviewer 420 determines the characteristic common to content items included in the cluster 410 is included in less than a threshold amount of content items received from various users or is received from users at less than a threshold rate, the reviewer 420 indicates to the online system 140 that the particular publishing user is exploiting one or more selection processes and identifies the characteristic common to content items included in the cluster 420 to the online system 140. In response to receiving the indication, the online system 140 performs one or more remedial actions to the particular publishing user, as further described above in conjunction with FIG. 3.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving content items from publishing users at an online system for presentation to users of the online system;
identifying opportunities to present content to users of the online system;
selecting, by the online system, content items from one or more publishing users for presentation to users of the online system via the identified opportunities;
generating an estimated revenue to the online system for presenting one or more content items received from each publishing user, the estimated revenue for presenting one or more content items received from a publishing user based on characteristics of the publishing user and characteristics of the one or more content items;
obtaining compensation from publishing users from whom content items selected for presentation to users of the online system was received in response to presenting the content items selected for presentation;
determining revenue received from each of at least a set of publishing users for presenting one or more content items based on compensation obtained from each publishing user of the set;
identifying one or more particular publishing users from whom a determined amount of revenue is at least a threshold amount less than the estimated revenue;
generating clusters of content items received from each of the identified one or more particular publishing users based on characteristics of the content items received from each of the identified one or more particular publishing users; and
reviewing the generated clusters of content items.

2. The method of claim 1, wherein identifying one or more particular publishing users from whom the determined amount of revenue is at least the threshold amount less than the estimated revenue comprises:
identifying a particular publishing user from whom the determined amount of revenue is less than a threshold multiple of the estimated revenue generated for presenting one or more content items from the particular publishing user.

3. The method of claim 1, wherein generating the estimated revenue to the online system for presenting one or more content items received from each publishing user comprises:
generating a probability distribution of estimated revenue from the publishing user for presenting a content item from the publishing user for each identified opportunity.

4. The method of claim 3, wherein identifying one or more particular publishing users from whom the determined amount of revenue is at least the threshold amount less than the estimated revenue comprises:
determining a number of opportunities to present content items to users of the online system where a content item from the particular publishing user was presented and the online system received compensation from the particular publishing user having less than a threshold position in the probability distribution of estimated revenue from the particular publishing user; and
identifying the particular publishing user if the determined number of opportunities equals or exceeds a threshold number.

5. The method of claim 1, wherein a characteristic of the content items received from each of the identified one or more particular publishing users is selected from a group consisting of: a type of bid amount included in the content items, a type of the content items, an objective included in the content items specifying a desired action by users to whom the content items were presented, a context in which the content items were presented to users, and any combination thereof.

6. The method of claim 1, wherein reviewing the generated clusters of content items comprises:
presenting each of the generated clusters to one or more human reviewers.

7. The method of claim 6, wherein presenting each of the generated clusters to one or more human reviewers comprises:
presenting different generated clusters to different human reviewers.

8. The method of claim 1, wherein reviewing the generated clusters of content items comprises:
determining a rate at which content items having at least a threshold amount of characteristics matching characteristics of content items included in a cluster including content items received from a particular publishing user have been received from publishing users of the online system; and
performing a remedial action affecting presentation of content items received from the particular publishing user in response to the rate being less than a threshold rate.

9. The method of claim 1, wherein reviewing the generated clusters of content items comprises:
determining a number of publishing users from whom content items having at least a threshold amount of characteristics matching characteristics of content items included in a cluster including content items received from a particular publishing user have been received by the online system; and
performing a remedial action affecting presentation of content items received from the particular publishing user in response to the number being less than a threshold.

10. The method of claim 9, wherein the remedial action is selected from a group consisting of: withholding content items received from the particular publishing user from inclusion in one or more selection processes, requesting additional compensation from the particular publishing user, and any combination thereof.

11. A computer program product comprising a non-transitory computer readable medium having instructions encoded thereon that, when executed by a processor, cause the processor to:
receive content items from publishing users at an online system for presentation to users of the online system;
identify opportunities to present content to users of the online system;
select, by the online system, content items from one or more publishing users for presentation to users of the online system via the identified opportunities;
generate an estimated revenue to the online system for presenting one or more content items received from each publishing user, the estimated revenue for presenting one or more content items received from a publishing user based on characteristics of the publishing user and characteristics of the one or more content items;
obtain compensation from publishing users from whom content items selected for presentation to users of the online system was received in response to presenting the content items selected for presentation;
determine revenue received from each of at least a set of publishing users for presenting one or more content items based on compensation obtained from each publishing user of the set;
identify one or more particular publishing users from whom a determined amount of revenue is at least a threshold amount less than the estimated revenue;
generate clusters of content items received from each of the identified one or more particular publishing users based on characteristics of the content items received from each of the identified one or more particular publishing users; and
review the generated clusters of content items.

12. The computer program product of claim 11, wherein identify one or more particular publishing users from whom the determined amount of revenue is at least the threshold amount less than the estimated revenue comprises:
identify a particular publishing user from whom the determined amount of revenue is less than a threshold multiple of the estimated revenue generated for presenting one or more content items from the particular publishing user.

13. The computer program product of claim 11, wherein generating the estimated revenue to the online system for presenting one or more content items received from each publishing user comprises:
generating a probability distribution of estimated revenue from the publishing user for presenting a content item from the publishing user for each identified opportunity.

14. The computer program product of claim 13, wherein identifying one or more particular publishing users from whom the determined amount of revenue is at least the threshold amount less than the estimated revenue comprises:
determine a number of opportunities to present content items to users of the online system where a content item from the particular publishing user was presented and the online system received compensation from the particular publishing user having less than a threshold position in the probability distribution of estimated revenue from the particular publishing user; and
identify the particular publishing user if the determined number of opportunities equals or exceeds a threshold number.

15. The computer program product of claim 11, wherein a characteristic of the content items received from each of the identified one or more particular publishing users is selected from a group consisting of: a type of bid amount included in the content items, a type of the content items, an objective included in the content items specifying a desired action by users to whom the content items were presented, a context in which the content items were presented to users, and any combination thereof.

16. The computer program product of claim 11, wherein review the generated clusters of content items comprises:
present each of the generated clusters to one or more human reviewers.

17. The computer program product of claim 16, wherein present each of the generated clusters to one or more human reviewers comprises:
present different generated clusters to different human reviewers.

18. The computer program product of claim 11, wherein review the generated clusters of content items comprises:
determine a rate at which content items having at least a threshold amount of characteristics matching characteristics of content items included in a cluster including content items received from a particular publishing user have been received from publishing users of the online system; and
perform a remedial action affecting presentation of content items received from the particular publishing user in response to the rate being less than a threshold rate.

19. The computer program product of claim 11, wherein review the generated clusters of content items comprises:
determine a number of publishing users from whom content items having at least a threshold amount of characteristics matching characteristics of content items included in a cluster including content items received from a particular publishing user have been received by the online system; and
perform a remedial action affecting presentation of content items received from the particular publishing user in response to the number being less than a threshold.

20. The computer program product of claim 19, wherein the remedial action is selected from a group consisting of: withholding content items received from the particular publishing user from inclusion in one or more selection processes, requesting additional compensation from the particular publishing user, and any combination thereof.
